(19) United States
(12) Patent Application Publication
(10) Pub. No.: US 2007/0278222 A1
(43) Pub. Date: Dec. 6, 2007

(54) FUEL CARTRIDGE FOR FUEL CELL

(76) Inventors: FENG-YI DENG, TAIPEI (TW); YU-LIN TANG, TAIPEI (TW)

Correspondence Address: G. LINK CO.,LTD, 3550 BELL ROAD, MINOOKA, IL, 60447, US

(21) Appl. No.: 11/421,264

(22) Filed: May 31, 2006

(51) Int. Cl. B65D 6/28; H01M 8/04

(52) U.S. Cl. 220/4.02; 429/34; 429/24; 429/22

(57) ABSTRACT

A fuel cartridge for a fuel cell comprises a fuel tank, an outlet and an electric unit. The fuel tank includes a sealed space constructed by a hollow case. The outlet is disposed on the case of the fuel tank, and fuel inside the fuel tank flows out from the outlet. The electric unit includes an electrical I/O interface and at least an electric component, and the electrical I/O interface is connected to the electric components.

### FIELD OF THE INVENTION

The present invention relates to a fuel storage component applied to a fuel cell, and more particularly, to a fuel cartridge that integrates circuits, sensors and logic devices to provide the status of the supplied fuel.

### BACKGROUND OF THE INVENTION

It is essential for fuel cells to be equipped with fuel storage components. For example, the direct methanol fuel cell (DMFC) utilizes a fuel tank to store liquid fuel like methanol solution. It thus becomes important to design a fuel tank used in a fuel cell to meet the requirements of modern electric devices. A conventional fuel tank is a kind of container, which merely stores fuel and does not provide any information about fuel supply. When fuel in the conventional fuel tank is exhausted, the fuel cell will receive no fuel and generate no power unless users always inspects the consumption of fuel and replenish fuel immediately.

In view of the aforesaid disadvantage, an improved fuel cartridge for a fuel cell is provided, which not only stores fuel, but also provides the information about the status of the supplied fuel.

### SUMMARY OF THE INVENTION

It is a primary object of the invention to provide a fuel cartridge for a fuel cell, which stores fuel, and provides the status of the supplied fuel as well.

In accordance with the aforesaid object of the invention, a fuel cartridge for a fuel cell is provided, which comprises a fuel tank, an outlet and an electric unit. The fuel tank includes a sealed space constructed of a hollow case. The outlet is disposed on the case of the fuel tank, and fuel inside the fuel tank flows out from the outlet. The electric unit includes an electrical I/O interface and at least an electric component, and the electrical I/O interface is connected to the electric components.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is an elevation view showing a fuel cartridge for a fuel cell according to a preferred embodiment of the invention;

FIG. 2 is an elevation view showing a fuel cartridge in accordance with an embodiment of the invention applied to a fuel cell; and

FIG. 3 is an elevation view showing a fuel cartridge for a fuel cell according to another preferred embodiment of the invention.

### DETAILED DESCRIPTION OF THE INVENTION

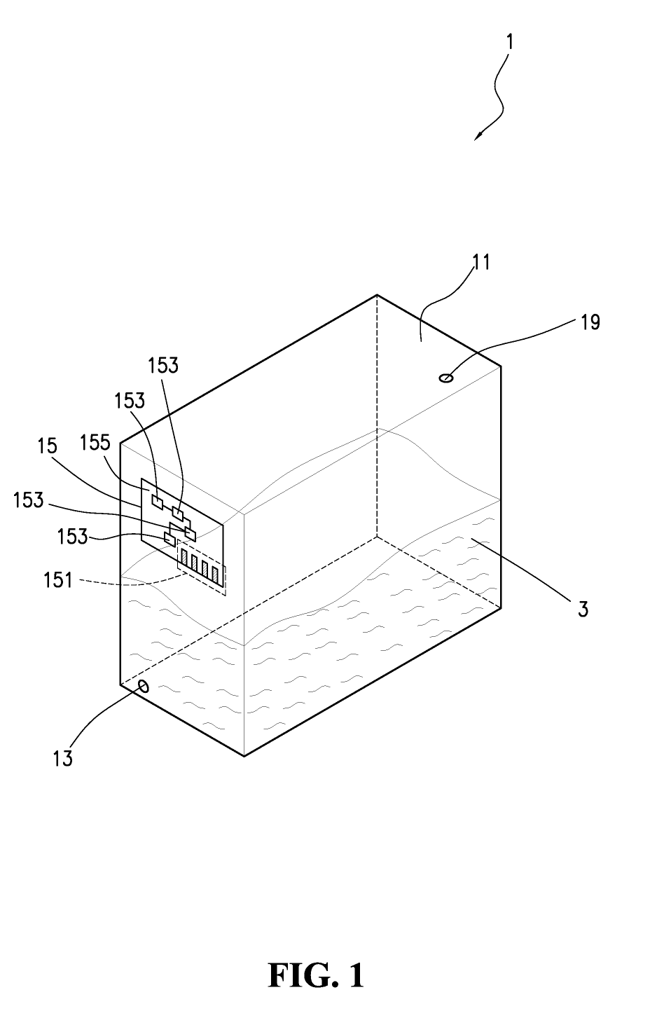

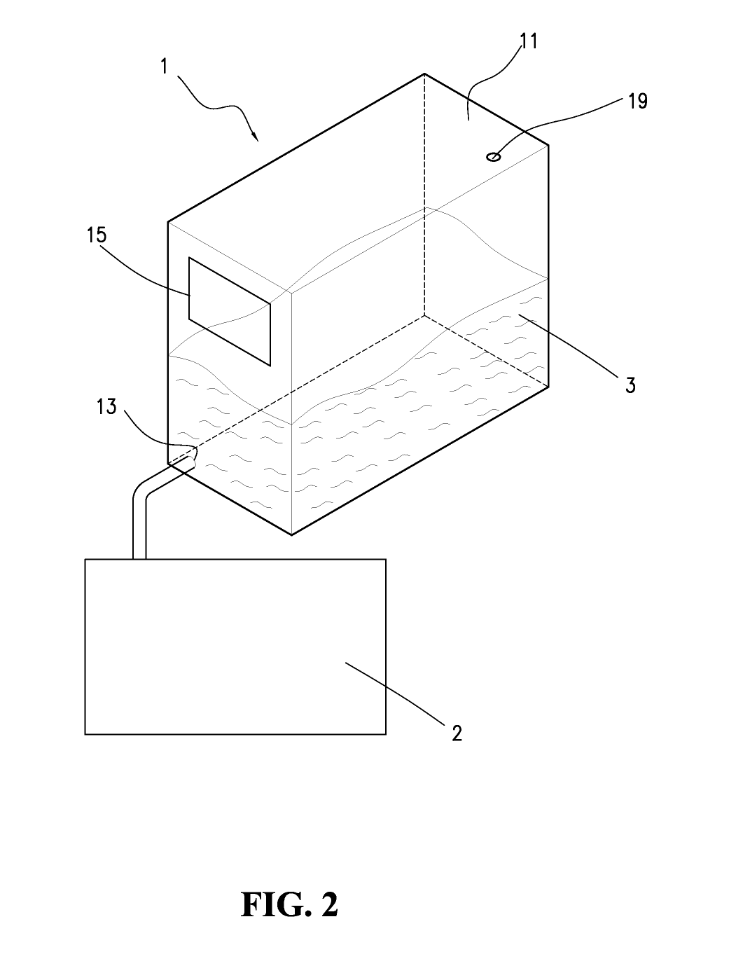

References are made to FIG. 1 and FIG. 2. FIG. 1 is an elevation view showing a fuel cartridge for a fuel cell according to a preferred embodiment of the invention. FIG. 2 is an elevation view showing that a fuel cartridge in accordance with an embodiment of the invention is applied to a fuel cell. A fuel cartridge 1 is used to provide fuel 3 for a fuel cell 2 having at least a membrane electrode assembly (MEA), and is connected with the fuel cell 2 through an outlet 13, thus supplying fuel 3 for the MEAs (not shown). In a DMFC, for example, the fuel cartridge 1 provides methanol solution 3 for the fuel cell 2. The fuel cartridge 1 comprises a fuel tank 11, an outlet 13 and an electric unit 15, which are separately described hereinafter. The fuel tank 11 includes a sealed space constructed by a hollow case. The space inside the fuel tank 11 is used to store fuel 3. The case may be made from polymers, anti-alcohol materials, acid-proof metals, or nonmetallic materials. The fuel 3 in the fuel tank 11 may flow out of the outlet 13, and then flow into the inside of the fuel cell 2.

For the additional ability of the fuel cartridge 1 to control over the status of fuel supply or to externally provide the information about the status of the supplied fuel, an electric unit 15 is deployed in the fuel cartridge 1. The electric unit 15 includes an electrical I/O interface 151 and at least an electric component 153. The electrical I/O interface 151 is electrically coupled to the electric components 153. The electric unit 15 further includes a circuit board 155 having a circuitry layout formed thereon. The electric component 153 may be soldered on the circuitry layout of the circuit board 155, and the circuit board 155 may be disposed on the case of the fuel tank 11. The electrical I/O interface 151 may be directly fabricated on the circuit board 155 in the form of gold fingers. Or, the electrical I/O interface 151 may include a connector soldered on the circuit board 155. An exemplar of the circuit board 155 may be a printed circuit substrate, and preferably a flexible circuit board, so the circuit board 155 can be compacted onto the surface of the fuel tank 11 according to the profile of the fuel tank 11, reducing the volume of the fuel cartridge 1.

The electric component 153 is, for example, a concentration sensor, a level sensor, a temperature sensor, or the composition thereof. The concentration sensor 153 is provided to detect the fuel concentration inside the fuel tank 11. The level sensor 153 is provided to sense the level of fuel inside the fuel tank 11. The temperature sensor 153 is provided to measure the temperature of fuel inside the fuel tank 11. The electric components 153 of the fuel cartridge 1 are composed of the aforementioned sensors. The analog signals produced by the sensors 153 are transmitted out through the electrical I/O interface 151.

In addition to the sensors, one of the electric component 153 may be a microcontroller or a logic chip. Hence, the analog signals from the sensors are received by the microcontroller 153. The microcontroller 153 converts the analog signals into digital signals, and then transmits the current status of the fuel cartridge 1 out through the electrical I/O interface 151.

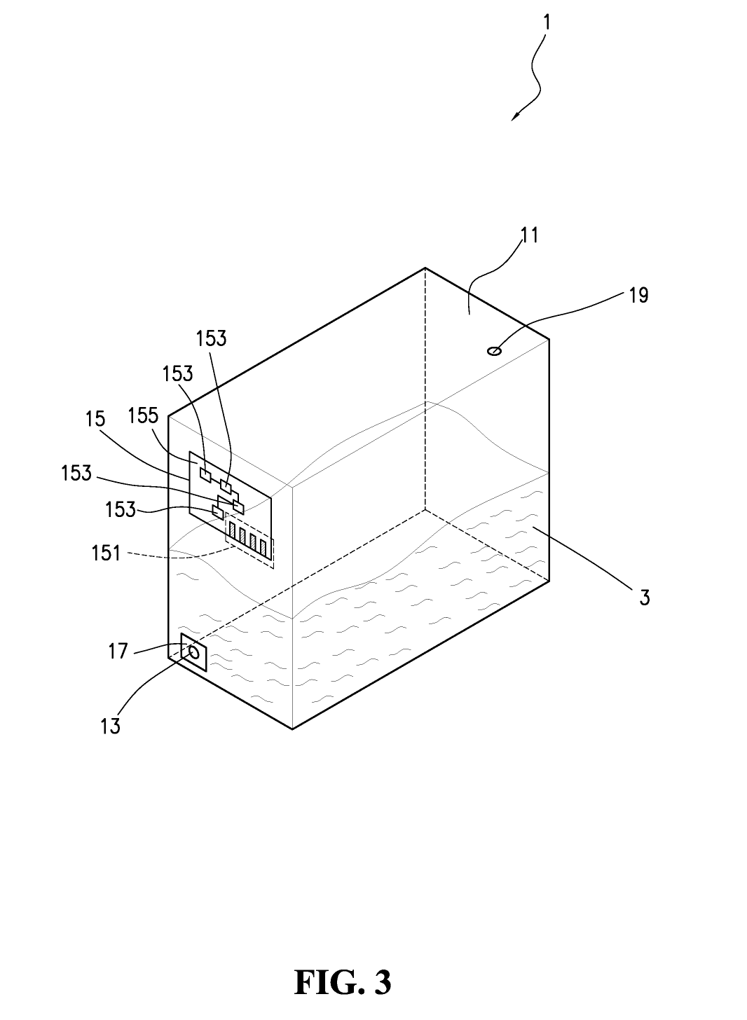

FIG. 3 is an elevation view showing a fuel cartridge for a fuel cell according to another preferred embodiment of the invention. Based on the structure of FIG. 1, the fuel cartridge 1 in FIG. 3 further includes a flow rate controller 17 that may be disposed around the outlet 13. The flow rate controller 17 is provided to adjust the amount of fuel flowing out of the fuel tank 11. The flow rate controller 17 may include a piezoelectric liquid jet head, and is controlled by a microcontroller. A non-return valve device (not shown), such as a check valve, may be also disposed on the terminal of the outlet 13 to prevent fuel from leaking.

Moreover, the fuel cartridge 1 includes an inlet 19 disposed on the case of the fuel tank 11 for injecting fuel hereinto. Some air may be supplemented from the inlet 19 to the inside of the fuel tank 11 for balancing the output pressure of fuel, and fuel thus flows out smoothly. A non-return valve device (not shown), such as a check valve, may be also disposed on the end of the inlet 19 to prevent fuel from leaking.

In another embodiment, the electrical I/O interface 151 may utilize other transmission standards like SMBus or I₂C signals.

The fuel cartridge of the invention is able to control over the status of supplying fuel, which is superior to a traditional fuel container. Therefore, it becomes convenient to use such a fuel cell employing the fuel cartridge of the invention.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and detail may be made therein without departing from the spirit and scope of the invention, as set forth in the following claims.

What is claimed is:

1. A fuel cartridge for a fuel cell, the fuel cartridge comprising:
a fuel tank including a sealed space constructed by a hollow case;
an outlet disposed on the case of the fuel tank, wherein a fuel inside the fuel tank flows out from the outlet; and
an electric unit including an electrical I/O interface and at least an electric component, wherein the electrical I/O interface is connected to the electric components.

2. The fuel cartridge of claim 1, further comprising an inlet disposed on the case of the fuel tank, and thereby a new fuel is injected into the fuel tank through the inlet.

3. The fuel cartridge of claim 2, wherein external air is supplemented to the inside of the fuel tank through the inlet for balancing a pressure when outputting fuel.

4. The fuel cartridge of claim 1, wherein the electric unit comprises a circuit board for deploying the electrical I/O interface and the electric components.

5. The fuel cartridge of claim 1, wherein the electric components comprising a concentration sensor, a level sensor, a temperature sensor, a microcontroller, a logic chip, or a composition thereof.

6. The fuel cartridge of claim 1, wherein the electrical I/O interface transmits signals produced by the electric components.

7. The fuel cartridge of claim 1, wherein the fuel is a liquid fuel.

8. The fuel cartridge of claim 1, further comprising a flow rate controller to adjust an amount of fuel flowing out of the outlet.

9. The fuel cartridge of claim 1, further comprising a non-return valve device disposed around the outlet.

10. The fuel cartridge of claim 3, further comprising a non-return valve device disposed around the inlet.
